(19) United States
(12) Patent Application Publication
(10) Pub. No.: US 2012/0143900 A1
(43) Pub. Date: Jun. 7, 2012

(54) Instant Search For Settings

(75) Inventors: Alex Ainslie, San Francisco, CA (US); Nicholas Jitkoff, Palo Alto, CA (US); Roma Shah, San Francisco, CA (US)

(73) Assignee: Google Inc., Mountain View, CA (US)

(21) Appl. No.: 13/074,898

(22) Filed: Mar. 29, 2011

Related U.S. Application Data
(60) Provisional application No. 61/420,107, filed on Dec. 6, 2010.

(51) Int. Cl. G06F 17/30

(52) U.S. Cl. 707/769; 707/E17.014

(57) ABSTRACT

Methods and systems for setting application settings using instant search are provided. A method for setting application settings using instant search may include receiving a first portion of user search input associated with an application setting and determining application settings from applications based on the first portion of the user search input. The method may also include displaying the application settings corresponding to the user search input in a results section. The method may further include receiving an update to the user search input and dynamically updating the results section based at least in part on the update. The method may also include setting application settings based on user setting input entered into the results section to adjust the application settings. A system for setting application settings using an instant search page may include an application setting determiner, a display manager and an application setting manager.

### CROSS REFERENCE TO RELATED APPLICATIONS

This application claims the benefit of U.S. Provisional Appl. No. 61/420,107 filed Dec. 6, 2010, which is hereby incorporated by reference in its entirety.

### TECHNICAL FIELD

The field relates to operating systems and search applications.

### BACKGROUND

Various software applications, such as productivity applications, web browsers, and operating systems, may have one or more application settings which can be adjusted by the user that affect the operation and/or appearance of each corresponding application. Such application settings may include startup behavior, date and time settings, autorun settings, home page designation, default search engines, a default web browser, account settings, synchronization settings, form autofill settings, theme settings, and the like.

FIG. 1 shows exemplary sources of application settings. Application settings may include operating system settings 110, application 1 settings 112, application 2 settings 114, computing device settings 116, and web browser settings 118. Operating system settings 110 may include, for example and without limitation, date and time, trackpad, language, sound input, and sound output. Computing device settings 116 may include network settings, such as ethernet settings, wifi settings, cellular settings, and virtual private network (VPN) settings. Application 1 settings 112 and/or application 2 settings 114 may include language, country, time zone, date format, time format, window options, and/or update indicators. Web browser settings 118 may include startup behavior, home page, default search provider, default browser, passwords, browsing data, themes, network proxy settings, and/or security settings. Applications may include these and other adjustable settings.

Each application of a computing device may have a different interface to access its own application settings. Furthermore, within each application, there may be multiple ways to access the same application setting. For example, an operating system may include a device manager to access computing device settings 116. The device manager may be accessed through a control panel, or alternatively, through a menu in the computing device software.

Each application may also have different terminology for similar application settings. For example, some applications and web browsers may label settings as “options,” whereas other applications and web browsers may label settings as “preferences.” As another example, font and language settings may be accessed together through an “under the hood” setting in one application, but accessed under an “appearance” setting in another application

However, accessing and changing settings across different applications may be cumbersome and time-consuming. For example, application setting interfaces and even application setting terminology can vary from application to application. Settings can be hard to find and adjusting settings may require navigating through different windows and menus in the hierarchy of applications.

### BRIEF SUMMARY

Embodiments relate to instant search for application settings. In an embodiment, a method for setting application settings using instant search may include receiving a first portion of user search input associated with an application setting and determining application settings from one or more applications based on the first portion of the user search input. The method may also include displaying the application settings corresponding to the user search input in a results section where the displayed application settings may include at least one adjustable application setting. The method may further include receiving an update to the user search input and dynamically updating the results section based at least in part on the update. The method may also include setting one or more of the application settings based on user setting input entered into the results section to adjust the application settings.

In another embodiment, a system for setting application settings using instant search may include a display manager configured to display application settings corresponding to user search input in a results section, wherein the displayed application settings include at least one adjustable application setting. The system may also include an application setting determiner configured to receive a first portion of the user search input associated with an application setting and determine the application settings from one or more applications based on the first portion of the user search input. The application setting determiner may also be configured to receive an update to the user search input and dynamically update the results section based at least in part on the update. The system may further include an application setting manager configured to set one or more of the application settings based on user setting input entered into the results section to adjust the application settings.

In an embodiment, a computer program product includes a computer readable storage medium having control logic stored therein that, when executed by a processor, causes the processor to display adjustable application settings, the control logic including a first computer readable program code to cause the processor to receive a first portion of user search input associated with an application setting and a second computer readable program code to cause the processor to determine application settings from one or more applications based on the first portion of the user search input. The control logic may also include a third computer readable program code to cause the processor to display the application settings corresponding to the user search input in a results section, wherein the displayed application settings include at least one adjustable application setting. The control logic may also include a fourth computer readable program code to cause the processor to receive an update to the user search input, a fifth computer readable program code to cause the processor to dynamically update the results section based at least in part on the update, and a sixth computer readable program code to cause the processor to set one or more of the application settings based on user setting input entered into the results section to adjust the application settings.

Further embodiments, features, and advantages, as well as the structure and operation of the various embodiments, are described in detail below with reference to the accompanying drawings.

### BRIEF DESCRIPTION OF THE FIGURES

The accompanying drawings, which are incorporated herein and form part of the specification, illustrate the embodiments and, together with the description, further serve to explain the principles of the invention and to enable a person skilled in the relevant art(s) to make and use the invention,

FIG. 1 is a block diagram of exemplary application settings.

FIG. 2 is a block diagram of a system for setting application settings using instant search according to an embodiment.

FIG. 3 is an illustration of a user interface for setting application settings using an instant search page according to an embodiment.

FIG. 4 is an illustration of a modified user interface for setting application settings using an instant search page according to an embodiment.

FIG. 5 is a flow diagram of a method for setting application settings using an instant search page according to an embodiment.

The features and advantages of the embodiments will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

While the present invention is described herein with reference to the illustrative embodiments for particular applications, it should be understood that the invention is not limited thereto. Those skilled in the art with access to the teachings provided herein will recognize additional modifications, applications, and embodiments within the scope thereof and additional fields in which the invention would be of significant utility.

In the detailed description of embodiments that follows, references to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

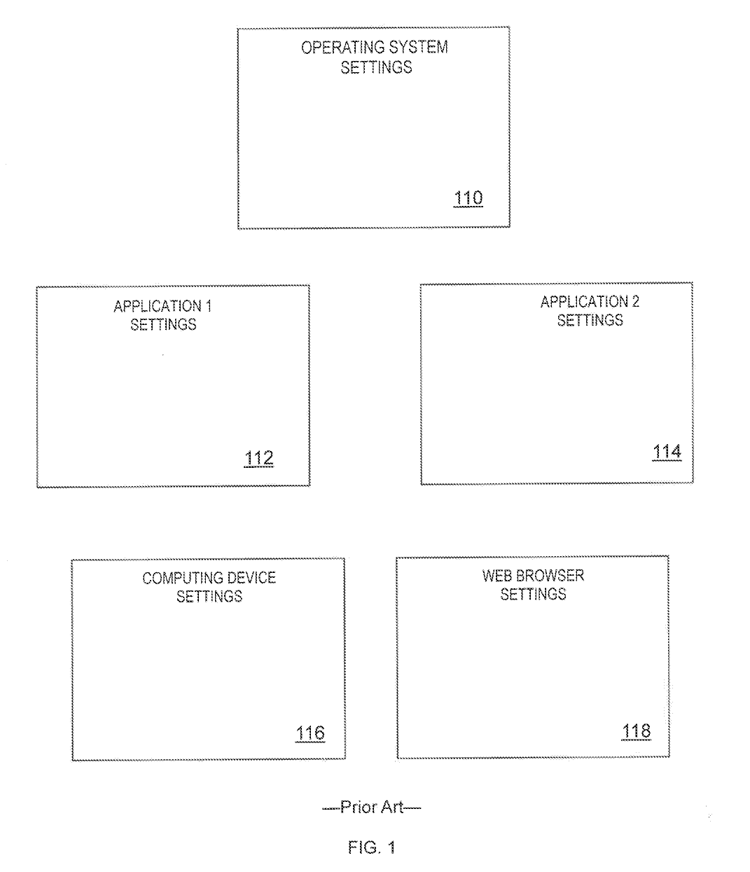

Each application, as shown for example in FIG. 1, may include multiple application settings. Each application may have a different interface to access its own application settings. Furthermore, within each application, there may be multiple ways to access the same application setting. For example, an operating system may include a device manager to access computing device settings 116. The device manager may be accessed through a control panel, or alternatively, through a menu in the computing device software. Also, each application may also have different terminology for similar application settings.

The embodiments described below provide for a more efficient and effective way to find, set or modify application settings. These embodiments include methods and systems for instant search for application settings. Application settings may be searched and modified through a settings search page, which may appear as a tab in the web browser, In other embodiments, a user may search for application settings through a separate window, menu bar, task bar, or some other interface.

In an example, a web browser may include a settings page with a keyword search interface. A user may enter search input into the keyword search interface, for example, by typing in all of part of a setting name or attribute. To determine one or more application settings corresponding to the user search input, various fields associated with application settings, such as a title or option, may be searched for the user search input string, or, in one alternative, for a keyword predicted from the user search input. Using the search results, application settings from one or more applications may be dynamically displayed on the settings page. For example, when the user types in “def,” the application settings “default search provider” and “default browser” may be displayed in the results section. At this point, the user may adjust one or more of the displayed settings, which may cause the application settings to be adjusted. In some cases, adjusting may also include entering settings that had not been set previously.

Or, in one alternative, a user may update the user search input by entering additional characters and/or modifying existing characters of the search input. In this example, the user may update the user search input “def” by adding additional characters to input “default theme” into the keyword search interface. As the search input is entered, or while or after the user is entering such input, application settings displayed on the settings page may be dynamically updated. In the example, once the user has finished entering “default theme,” the adjustable setting for “themes” may be displayed on the settings page. The application settings may then be set based on the adjustments to the theme setting (e.g. user setting input).

### Example Systems For Instant Search For Settings

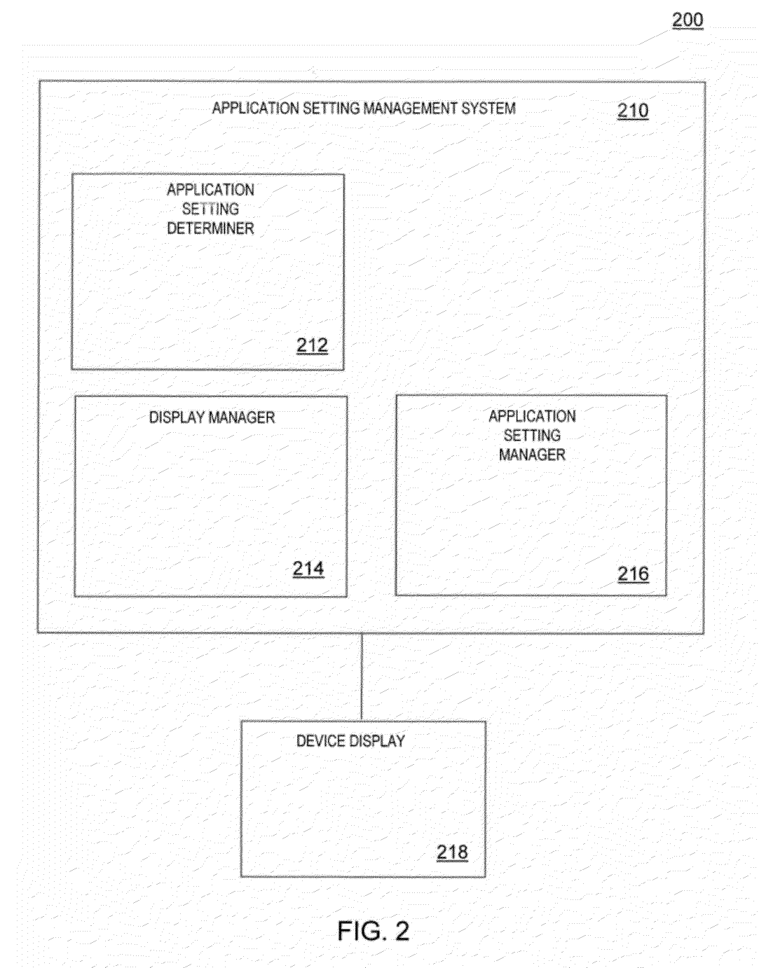

FIG. 2 is a block diagram of exemplary system 200 for setting application settings using instant search according to an embodiment. System 200, or any combination of its components, may be part of or may be implemented with a computing device. Examples of computing devices include, but are not limited to, a computer, workstation, distributed computing system, computer cluster, embedded system, stand-alone electronic device, networked device, mobile device (e.g. mobile phone, smart phone, navigation device, tablet or mobile computing device), rack server, set-top box, or other type of computer system having at least one processor and memory. Such a computing device may include software, firmware, hardware, or a combination thereof. Software may include one or more applications and an operating system. Hardware can include, but is not limited to, a processor, memory and user interface display. System 200 may include an application setting management system 210 in communication with device display 218. Application setting management system 210 may include an application setting determiner 212, a display manager 214, and an application setting manager 216.

According to an embodiment, application setting determiner 212 may determine application settings from one or more applications based on user search input entered into a settings search interface, such as a settings search tab or page. Application setting determiner 212 may make this determination by performing a search on fields and values associated with the application settings. In one example, the user search input comprises the word “default.” Application setting determiner 212 may then search one or more fields or values, such as a title or adjustable option, of one or more application settings to determine application settings corresponding to the user search input.

In a further embodiment, application setting determiner 212 may predict at least one of the application settings based at least in part on the user search input. In one example, the user search input comprises the letter “a,” such as “auto-fill” or “automatic.” Application setting determiner 212 may then predict application settings which start with the letter a. In another example, the user search input comprises the letters “def.” Application setting determiner 212 may then predict application settings which include the word “default.”

Application setting determiner 212 may also receive an update to the user search input and automatically determine the application settings based on the update to the user search input, according to an embodiment. In one example, user search input may include the letter “a.” Later, the user may enter an update to the user search input such that that the new user search input is “auto.” Application setting determiner 212 may receive the update to the user search input and automatically determine the application settings based on the updated user search input “auto.” In the example, application setting determiner 212 may determine application settings including the string “auto,” such as “automatically,” based on the updated user search input.

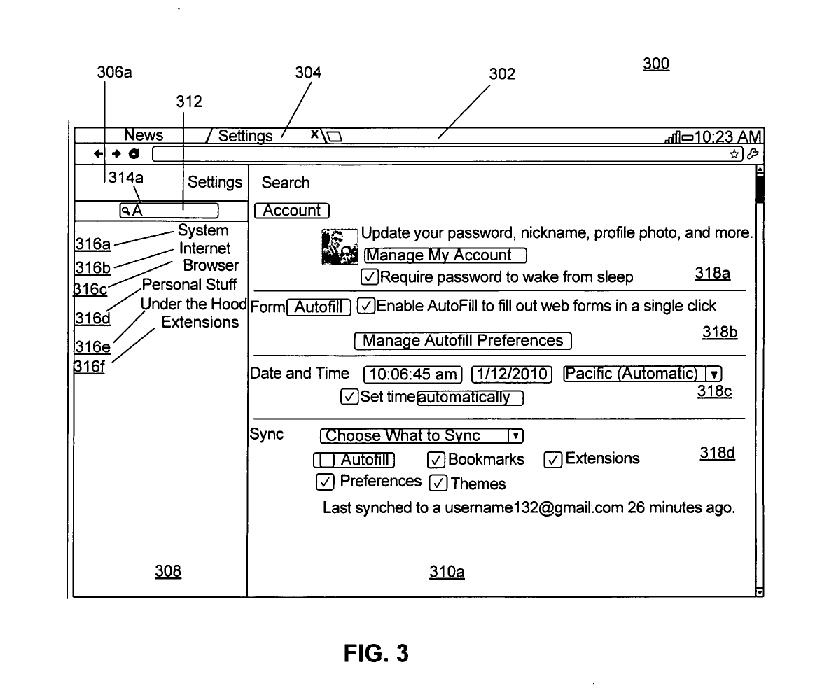

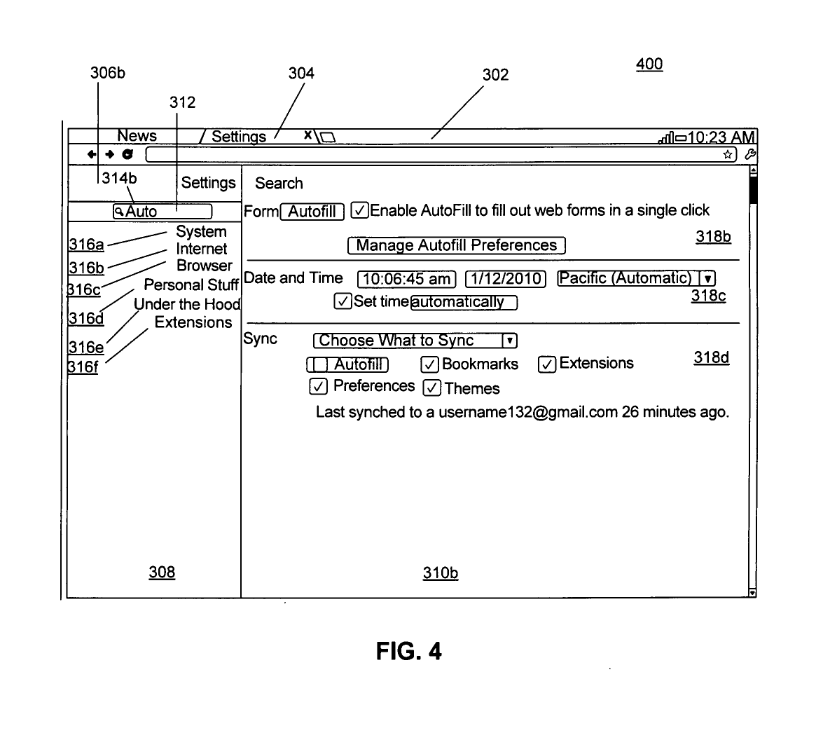

Display manager 214 may display the application settings corresponding to the user search input in the settings search page, according to an embodiment. Display manager 214 may dynamically display updated application settings, such as when a user updates the user search input. Example displays of searched application settings are shown in FIGS. 3 and 4.

Application setting manager 216 may set the application settings based on user setting input entered into the settings search page to adjust the application settings, according to an embodiment. The may include coordinating with respective applications, if necessary, to set the settings for the applications. In other cases, operating systems may allow for a more direct ability to modify various application settings.

### Illustrated User Interfaces For Instant Search Settings

FIG. 3 is an illustration of a user interface for instant search settings according to an embodiment. As shown in display 300, software application 302 may be a web browser with a tabbed interface. In other embodiments, software application 302 may be a productivity application, such as a word processing application, a spreadsheet application, and/or a database application. In still other embodiments, software application 302 may be a utility application, such as a hardware device manager or a network manager, or an operating system, such as an operating system shell or interface.

As shown in FIG. 3, software application 302 may include a tabbed interface with settings tab 304, When settings tab 304 is active, a settings page 306a may be displayed in the main window of software application 302. Settings page 306a may include a navigation section 308, and a results section 310a. In one embodiment, settings page 306a may correspond to a specific software application 302, such as a web browser, word processing application, or network manager. For example, settings page 306a may offer an interface to adjust one or more settings of a web browser. In other embodiments, settings page 306a may correspond to multiple software applications, such as all web browsers installed on a system, all currently executing applications, or all currently installed applications. As one example, settings page 306a may offer an interface to adjust one or more settings of all currently executing software applications (e.g. web browser, word processing application). For example, all applications settings shown in FIG. 1 may be available for search.

In one embodiment, navigation section 308 of settings page 306a may include a search keyword interface 312. Search keyword interface 312 may be a text box, for example, which accepts characters typed by a user. As shown in FIG. 3, a user has entered user search input 314a, the letter a, into search keyword interface 312.

In other embodiments, search keyword interface 312 may be incorporated into an application and/or operating system in other ways. In one embodiment, software application 302 may include a search keyword interface 312 in a toolbar. For example, a web browser may include search keyword interface 312 alongside a location bar. Or, as other examples, an operating system may incorporate search keyword interface 312 into a taskbar or as a stand-alone widget or gadget,

In one embodiment, navigation section 308 may also include one or more settings links 316a, 316b, 316c, 316d, 316e, 316f. Each settings link 316a, 316b, 316c, 316d, 316e, 316f may be associated with one or more application settings. System link 316a, for example, may be associated with one or more adjustable system settings. Likewise, Internet link 316b may be associated with one or more adjustable interne settings. In other embodiments, navigation section 312 may include other settings links, or no settings links at all.

Settings page 306a may also include results section 310a. Results section 310a may include at least one application setting, which may be adjustable. In one example, before a user has entered a keyword and/or selected a settings link, no application settings may be shown in results section 310a. In another example, before a user has entered a keyword and/or selected a settings link, the most popular application settings may be shown in results section 310a.

As shown in illustration 300 of FIG. 3, application settings 318a, 318b, 318c, 318d may be displayed in results section 310a. Each setting in results section 310a may be automatically generated based at least in part on a keyword and/or user search input entered into search keyword interface 312. In one exemplary illustration, a user has entered user search input 314a. (e.g. the letter a) into search keyword interface 312. One or more application settings 318a, 318b, 318c, 318d may then be automatically generated based at least in part on user search input 314a.

In the exemplary illustration, each adjustable setting 318a, 318b, 318c, 318d may be associated with user search input 314a. For example, adjustable setting 318a (e.g. Account) may be associated. with user search input 314a because it begins with the same letter as user search input 314a. Adjustable setting 318b (e.g. Form Autofill) may be associated with user search input 314a because it includes a word (e.g. Autofill) beginning with the same letter as user search input 314a. Adjustable setting 318c (e.g. Date and Time) may be associated with user search input 314a because it includes an option to “set time automatically” that includes a word (e.g. automatically) that begins with the same letter as user search input 314a. Finally, adjustable setting 318d (e.g. Sync) may be associated with user search input 314a because it includes an option (e.g. AutoFill) that begins with the same letter as user search input 314a.

In another example, a user may enter a user search input 314a (e.g. the word Autofill). Adjustable setting 318b (e.g. Form Autofill) and adjustable setting 318d (e.g. Sync) may then be generated in results section 310a. In the example, each adjustable setting 318 generated in results section 310a may be associated with user search input 314a (e.g. the word Autofill). For example, adjustable setting 318b (e.g. Form Autofill) may be associated with the Autofill user search input because it includes the user search input in its title. Adjustable setting 318d may be associated with the Autofill user search input because it includes the user search input Autofill as an option.

Portions of the application settings corresponding to the user search input may be highlighted, or emphasized. In one embodiment, words of an application setting corresponding to the user search input are highlighted. In one such embodiment, as shown in FIG. 3, “account” is highlighted in adjustable setting 318a, “autofill” is highlighted in adjustable setting 318b, “automatically” is highlighted in adjustable setting 318c, and “autofill” is highlighted in adjustable setting 318d. These highlighted terms correspond to the user search input letter ‘a’. In another embodiment, partial words and/or characters of an application setting corresponding to the user search input may be highlighted.

FIG. 4 is an illustration 400 of a user interface for instant search settings according to an embodiment. Software application 302 with settings page 306a is illustrated again in screen shot 400. Updates may be made to the user search input 314a, and received by application setting management system 210. In one embodiment, receiving an update to the user search input includes receiving the next character of the user search input. In another embodiment, receiving an update to the user search input includes receiving a modification to a character of the user search input, such as a deletion or an edit.

As shown in FIG. 4, user search input 314b may be an update to initial user search input 314a. As illustrated, a user has continued inputting text into search keyword interface 312. Originally a single letter, updated user search input 314b may be multiple letters, such as the word (or prefix) “auto.”

After an update to user search input has been received, application settings may be automatically determined and displayed based on the update. Some application settings which corresponded to the initial user search input may also correspond to the updated user search input. For example, application settings 318b, 318c, and 318d may each still correspond with the update to user search input, and thus, be displayed in the updated results section 310b. On the other hand, other application settings which corresponded to the initial user search input may not correspond to the updated user search input. For example, application setting 314a may not correspond with the update to user search input, and thus, be removed from the updated results section 310b.

Updates to the results section 310 may occur dynamically in real time as updates to the user search input are received. For example, updated results section 310b may be updated after the letters u, t, and o are received. In one alternative, update of the results section 310b may be temporarily delayed, for example, to wait until a user finishes his or her thought (as indicated by a delay).

### Example Method For Instant Search For Settings

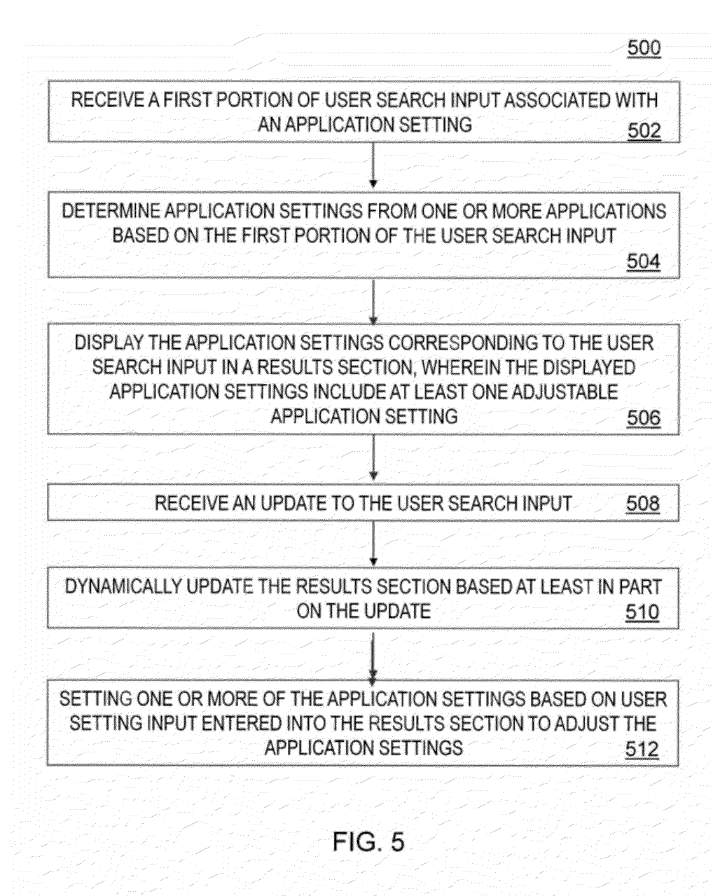

FIG. 5 is a flow diagram of a method 500 for setting application settings using instant search according to an embodiment. Method 500 begins at stage 502 when a first portion of user search input associated with an application setting may be received. A user may enter a first portion of user search input, for example, by typing into a search keyword interface. The search keyword interface may be located, for example, on a settings page, in a toolbar, or in a taskbar. A first portion of the user search input may be one or more alphanumeric characters, such as a letter and/or a number. The first portion of user search input may also be some fragment or part of a word or a word among multiple words.

A user search input may be associated with at least one setting to be adjusted. In one example, a user may wish to change the default home page for the browser. Initially, the user may type “def” into the search keyword interface. The user search input “def” may be associated with one or more settings to be adjusted. In the example, “def” may be associated with “default” settings such as a “default browser” setting as well as a “default home page” setting.

In one embodiment, the search keyword interface is located on results section of a software application with a tabbed interface. The software application may include a settings page (e.g. settings page 306a) with a navigation section (e.g. navigation section 308) and a results section (e.g. results section 310a). For example, the settings page may be displayed under a settings tab 304 in a tabbed interface.

Initially, when the settings page is loaded, the results section may be empty. Or, alternatively, the results section may initially be populated with one or more application settings. For example, the most used settings and/or the most recently changed settings may be automatically generated in the results section. Step 502 may be implemented by application setting determiner 212.

At stage 504, application settings from one or more applications may be determined based on the first portion of the user search input. User search input may be entered into a text box, such as search keyword interface 312. Determining application settings may include performing a search on fields and values associated with the application settings. In one example, a search for the user search input may be performed on the title of each application setting. In another example, each adjustable field of an application setting may be searched for a word beginning with the user search input.

When determining application settings based on a portion or all of the user search input, the application settings searched may be limited or unlimited. In one embodiment, the application settings search may be limited to a single application, such as the currently selected application. In other embodiments, the application settings search may be limited to a group of application, such as by type (e.g. all web browsers, all word processors, the operating system), or class (e.g. all network applications, all utility applications). In still other embodiments, the application settings searched may correspond to all open applications, or all installed applications.

In one embodiment, an application may be executed in order to search its application settings. In another embodiment, an application may not be executed to search its application settings. In some cases, settings may be stored in a table, data source, or available without the need to execute certain applications. A results section or settings search page may be displayed in an application, such as a web browser.

In one embodiment, application settings may be determined from only the application displaying the results section (e.g. application settings for a web browser may only be displayed in the results section in the web browser). In another embodiment, application settings for multiple applications may be determined in a single results section, including application settings separate from the application that is displaying the results section or settings search page.

Application settings may be determined based on a user profile. In one embodiment, a user profile may include application settings repeatedly accessed and/or changed by a user. Such popular application settings may then be more likely to be displayed on the results section. In other cases, a user profile may provide security settings that may filter or modify what settings are returned as a result of a settings search. Stage 504 may be implemented by application setting determiner 212.

Next, at stage 506, application settings corresponding to the user search input may be displayed in the results section. The results section may be displayed, for example, on a settings page in a web browser. In one embodiment, the results section may be displayed on a tab in a tabbed interface. In another embodiment, applications settings corresponding to user search input may be displayed next to a search keyword interface, such as in a pop-up menu. In another embodiment, applications settings may be displayed in a new interface or window. One or more application settings may be displayed. In one embodiment, the application settings displayed may be limited to the most relevant application settings, e.g. the five most relevant application settings, or the ten most relevant application settings.

The results section may be based at least in part on the user search input, and include one or more application settings associated with the user search input. In one example, the application settings generated in the results section may start with the same word as the user search input. In another example, the application settings generated in the results section may include part of the user search input as an option. And in yet another example, the application settings generated may be related to the user search input (e.g. synonymous to a user search input).

In one embodiment, the results section may be generated automatically after the user enters the first character of a keyword (e.g. after entering a user search input). In another embodiment, the results section may be generated after the user enters multiple characters of a keyword. The one or more application settings displayed in the results section may be predicated based at least in part on the user search input. In one embodiment, a keyword may be predicted based on the user search input of a partial word. For example the keyword “default” may be predicted based on user search input “def.” In another embodiment, the keyword “password” may be predicted based on user search input “passw.” Such keyword predicts may then be used to search for corresponding application settings.

A part of each application setting in the results section may be highlighted to illustrate its connection with the user search input. For example, when the user search input is “def,” the word “default” in one or more corresponding application settings may be displayed with yellow highlighting. As another example, when the user search input is “a,” words beginning with the letter “a” may be underlined and bolded.

When the results section is populated with one or more application settings, each application setting may be adjusted directly from the results section, without having to traverse any additional menu structure or application interface. Thus, instant search settings may provide an easy-to-use interface for quickly finding and changing multiple application settings for multiple applications. Stage 506 may be implemented by display manager 214.

At stage 508, an update to the user search input may be received. An update may be a change, such as a revision, addition, or deletion, of a character from the user search input. In one example, as each additional character is entered into the search keyword interface, a new update to the user search input may be generated. In another example, as user search input is revised (i.e. characters are deleted and/or changed), an update to the user search input may be received.

At stage 510, the results section may be dynamically updated based at least in part on the update to the user search input. The results section may be dynamically updated as the user enters (or removes) each new alphanumeric character into search keyword interface 312. For example, one or more application settings may be added or deleted from the results section with each new character entered into search keyword interface 312.

At stage 512, application settings may be set based on user setting input entered into the settings search page. The user setting input may be entered with the intent to adjust application settings. Examples of user setting input include, for example and without limitation, selecting a setting radio button, selecting one or more setting checkboxes, adjusting a slider, or selecting one or more options from a drop-down menu. Stage 512 may be implemented by application setting manager 216.

Stages 502-512 may be implemented by application setting determiner 212, display manager 214 or a combination of these components. According to a further embodiment, settings may be established or changed using application setting manager 216.

Because the application settings in the results section may be generated from an accurate prediction of the user's intentions, a user might not have to enter a full keyword. As a result, the interface for changing settings may be faster and more intuitive than conventional methods for changing settings. Furthermore, a user may avoid the need to open applications, traverse icons and menus, or consult help manuals to find settings for and among multiple applications.

Aspects of the embodiments for exemplary systems 200-400, such as application setting determiner 212, display manager 214 and application setting manager 216, and/or method 500 or any part(s) or function(s) thereof may be implemented using hardware, software modules, firmware, tangible computer readable or computer usable storage media having instructions stored thereon, or a combination thereof and may be implemented in one or more computer systems or other processing systems.

The summary and abstract sections may set forth one or more but not all exemplary embodiments of the present invention as contemplated by the inventor(s), and thus, are not intended to limit the present invention and the appended claims in any way.

Embodiments of the present invention have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed. The breadth and scope of the present invention should not be limited by any of the above-described exemplary embodiments.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

1. A computer-implemented method for setting application settings using instant search, comprising:
receiving a first portion of user search input associated with an application setting;
determining application settings from one or more applications based on the first portion of the user search input;
displaying the application settings corresponding to the user search input in a results section, wherein the displayed application settings include at least one adjustable application setting stored on a remote computing device;
receiving an update to the user search input, wherein the update includes one or more of a next character of the user search input or a modification to a character of the user search input;
dynamically updating the results section based at least in part on the updated user search input, wherein the updated results section includes at least one adjustable application setting and excludes application settings corresponding to the first portion of the user search input but not the updated user search input; and
setting one or more of the application settings based on user setting input entered into the results section to adjust the application settings.

2. (canceled)

3. (canceled)

4. The method of claim 1, wherein the dynamically updating includes automatically determining and displaying the application settings in real time as each next portion of the update to the user search input is entered.

5. The method of claim 1, wherein the displaying the application settings in the results section includes displaying the application settings in a web browser settings page that receives the user search input.

6. The method of claim 1, wherein the displaying the application settings in the results section includes displaying the application settings in a tabbed interface that receives the user search input.

7. The method of claim 1, wherein the displaying the application settings includes highlighting portions of the application settings corresponding to the user search input.

8. The method of claim 1, wherein the determining application settings includes obtaining application settings from two or more applications based on user search input.

9. The method of claim 1, wherein the determining application settings includes predicting at least one of the application settings based at least in part on the user search input.

10. The method of claim 1, wherein the determining application settings includes performing a search on fields and values associated with the application settings.

11. The method of claim 1, wherein the determining application settings includes determining operating system settings.

12. The method of claim 1, wherein the determining application settings includes determining at least one of computing device settings, user preference settings and web browser settings.

13. The method of claim 1, wherein the determining application settings includes executing at least one of the one or more applications.

14. The method of claim 1, wherein the determining application settings includes determining application settings for an application separate from the application that is displaying the settings search page.

15. The method of claim 1, wherein the determining application settings includes determining application settings based on a user profile.

16. A system for setting application settings using instant search, comprising:
a display manager. implemented on a computing device and configured to display application settings corresponding to user search input in a results section, wherein the displayed application settings include at least one adjustable application setting stored on a remote computing device;
an application setting determiner, implemented on the computing device and configured to:
receive a first portion of the user search input associated with an application setting;
determine the application settings from one or more applications based on the first portion of the user search input;
receive an update to the user search input, wherein the update includes one or more of a next character of the user search input or a modification to a character of the user search input; and
dynamically update the results section based at least in part on the updated user search input, wherein the updated results section includes at least one adjustable application setting and excludes application settings corresponding to the first portion of the user search input but not the updated user search input; and
an application setting manager configured to set one or more of the application settings based on user setting input entered into the results section to adjust the application settings.

17. (canceled)

18. (canceled)

19. The system of claim 16, wherein the application setting determiner is further configured to automatically determine and display the application settings in real time as each next portion of the update to the user search input is entered.

20. The system of claim 16, wherein the display manager is further configured to display the application settings in a web browser settings page that receives the user search input.

21. The system of claim 16, wherein the display manager is further configured to display the application settings in a tabbed interface that receives the user search input.

22. The system of claim 16, wherein the display manager is further configured to highlight portions of the application settings corresponding to the user search input.

23. The system of claim 16, wherein the application setting determiner is further configured to obtain application settings from two or more applications based on user search input.

24. The system of claim 16, wherein the application setting determiner is further configured to predict at least one of the application settings based at least in part on the user search input.

25. The system of claim 16, wherein the application setting determiner is further configured to perform a search on fields and values associated with the application settings.

26. The system of claim 16, wherein the application setting determiner is further configured to determine operating system settings.

27. The system of claim 16, wherein the application setting determiner is further configured to determine at least one of computing device settings, user preference settings and web browser settings.

28. The system of claim 16, wherein the application setting determiner is further configured to execute at least one of the one or more applications.

29. The system of claim 16, wherein the application setting determiner is further configured to determine application settings for an application separate from the application that is displaying the settings search page.

30. The system of claim 16, wherein the application setting determiner is further configured to determine application settings based on a user profile.

31. A computer program product comprising a non-transitory computer readable storage medium having control logic stored therein that, when executed by a processor, causes the processor to display adjustable application settings, the control logic comprising:
a first computer readable program code to cause the processor to receive a first portion of user search input associated with an application setting;
a second computer readable program code to cause the processor to determine application settings from one or more applications based on the first portion of the user search input;
a third computer readable program code to cause the processor to display the application settings corresponding to the user search input in a results sectionₛ wherein the displayed application settings include at least one adjustable application setting stored on a remote computing device;
a fourth computer readable program code to cause the processor to receive an update to the user search input, wherein the update includes one or more of a next character of the user search input or a modification to a character of the user search input;
a fifth computer readable program code to cause the processor to dynamically update the results section based at least in part on the updated user search input, wherein the updated results section includes at least one adjustable application setting and excludes application settings corresponding to the first portion of the user search input but not the updated user search input; and
a sixth computer readable program code to cause the processor to set one or more of the application settings based on user setting input entered into the results section to adjust the application settings.

32. The method of claim 1, wherein the determining application settings includes accessing one or more stored application settings.

33. The method of claim 1, wherein the determining application settings includes determining application settings for a currently executing application.

34. The system of claim 16, wherein the application setting determiner is further configured to access one or more stored application settings.

35. The system of claim 16, wherein the application setting determiner is further configured to determine application settings for a currently executing application.

36. The method of claim 1, wherein the at least one adjustable application setting displayed in the results section includes application settings stored on a remote computing device and application settings stored on a local computing device.

37. The method of claim 36, wherein the at least one adjustable application setting displayed in the results section further includes at least one operating system setting and at least one computing device setting.
